(19) United States
(12) Patent Application Publication
(10) Pub. No.: US 2012/0215767 A1
(43) Pub. Date: Aug. 23, 2012

(54) AUGMENTING SALES AND SUPPORT INTERACTIONS USING DIRECTED IMAGE OR VIDEO CAPTURE

(76) Inventors: Mike Myer, Bozeman, MT (US); Laef Olson, Bozeman, MT (US)

(21) Appl. No.: 13/032,194

(22) Filed: Feb. 22, 2011

(51) Int. Cl. G06F 17/30

(52) U.S. Cl. 707/722; 707/769; 707/E17.03

(57) ABSTRACT

Systems and methods provide product information based on image data received from a communications device such as a cell phone. The image data may be used to identify particular configuration for a product, and may be used to determine if queries regarding the product are to be handled in-person by a support agent or if an automated response can be provided.

### FIELD

This disclosure relates generally to systems and methods providing customer support, and more particularly, to augmenting sales and support interactions using directed image or video capture.

### BACKGROUND

Initial consumer product support or sales interactions often begin with the consumer having very little knowledge of a product, but having the product available in front of them, either in a store before purchase or after purchase in the consumer's home or work environment. When the consumer has a question about product quality issues, the consumer must record some specific product identifiers and determine how to contact the company supplying the product. When there exist subtle variations in product identifiers like model or serial numbers that must be recorded by the consumer, the consumer is likely to make transcription errors or to record the wrong information.

With the emergence of digital cameras on cell phones, the ability to capture images of one-dimensional or two-dimensional bar code (see e.g., the web site “en.wikipedia.org/wiki/QRcode”) bar codes have emerged as a capability well known in the art. This photo scanning of bar codes for information lookup can thus be used for product identification to obtain product information (see e.g., the web site“redlaser.com/”). Examples of standard activities in the art for consumer pre-sales bar code scanning include price comparison, finding stores or other locations (such as libraries) offering a product, storing information for later purchase (hot-listing) and identifying potential allergens in the ingredients of a food product.

### BRIEF DESCRIPTION OF THE DRAWINGS

For a better understanding of the present invention, reference may be made to the accompanying drawings in which:

FIG. 1 is a block diagram of a system according to embodiments of the invention;

FIGS. 2A-2C are flowcharts illustrating methods for providing customer support using images on a customer device;

FIG. 3 is a flowchart illustrating methods for providing sales support using images on a customer device;

FIG. 4 is a flowchart illustrating methods for providing customer support using an application resident on a customer device;

FIGS. 5A and 5B are example user interfaces;

FIG. 6 is a block diagram of an example embodiment of a computer system upon which embodiments of the inventive subject matter can execute.

### DETAILED DESCRIPTION

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the inventive subject matter, and it is to be understood that other embodiments may be utilized and that logical, mechanical, electrical and other changes may be made without departing from the scope of the inventive subject matter.

Some portions of the detailed descriptions which follow are presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the following discussions, terms such as “processing” or “computing” or “calculating” or “determining” or “displaying” or the like, refer to the action and processes of a computer system, or similar computing device, that manipulates and transforms data represented as physical (e.g., electronic) quantities within the computer system's registers and memories into other data similarly represented as physical quantities within the computer system memories or registers or other such information storage, transmission or display devices.

In the Figures, the same reference number is used throughout to refer to an identical component that appears in multiple Figures. Signals and connections may be referred to by the same reference number or label, and the actual meaning will be clear from its use in the context of the description. Also, please note that the first digit(s) of the reference number for a given item or part of the invention should correspond to the Figure number in which the item or part is first identified.

The description of the various embodiments is to be construed as exemplary only and does not describe every possible instance of the inventive subject matter. Numerous alternatives could be implemented, using combinations of current or future technologies, which would still fall within the scope of the claims. The following detailed description is, therefore, not to be taken in a limiting sense, and the scope of the inventive subject matter is defined only by the appended claims.

For illustrative purposes, various embodiments may be discussed below with reference to a company customer support department that accepts multiple textual channels as a means of customer communication. This is only one example of a suitable environment and is not intended to suggest any limitation as to the scope of use or functionality of the invention. Neither should it be interpreted as having any dependency or requirement relating to any one or a combination of components illustrated in the exemplary operating environment

### Overview

The systems and methods of the various embodiments provide a means for a consumer to gain additional information differentiating similar products via product, quality ratings and feature comparison matrices, configuration explanations or any of numerous researching activities. Further, in a support scenario, the consumer can relay exact product details to the product's support agents or research solutions to common product defects or other issues.

Additionally, a consumer may subsequently contact a company with a support question on a product that has to do with product configuration or assembly. Systems exist to handle the communication and workflow for solving these interactions either live, such as via phone or internet chat, or delayed, such as with email, or perhaps even the combination of these channels in some form (see, e.g., the web site “www.rightnow.com/”).

An unusual and novel aspect of configuration or assembly issues, however, has not been addressed via the traditional methods in the art; specifically lacking is the visual aspects of understanding the current product status as compared with the correct status. The visual elements may, in many cases, be essential for the support agent to understand the problem without relying on the inexpert description supplied by the consumer.

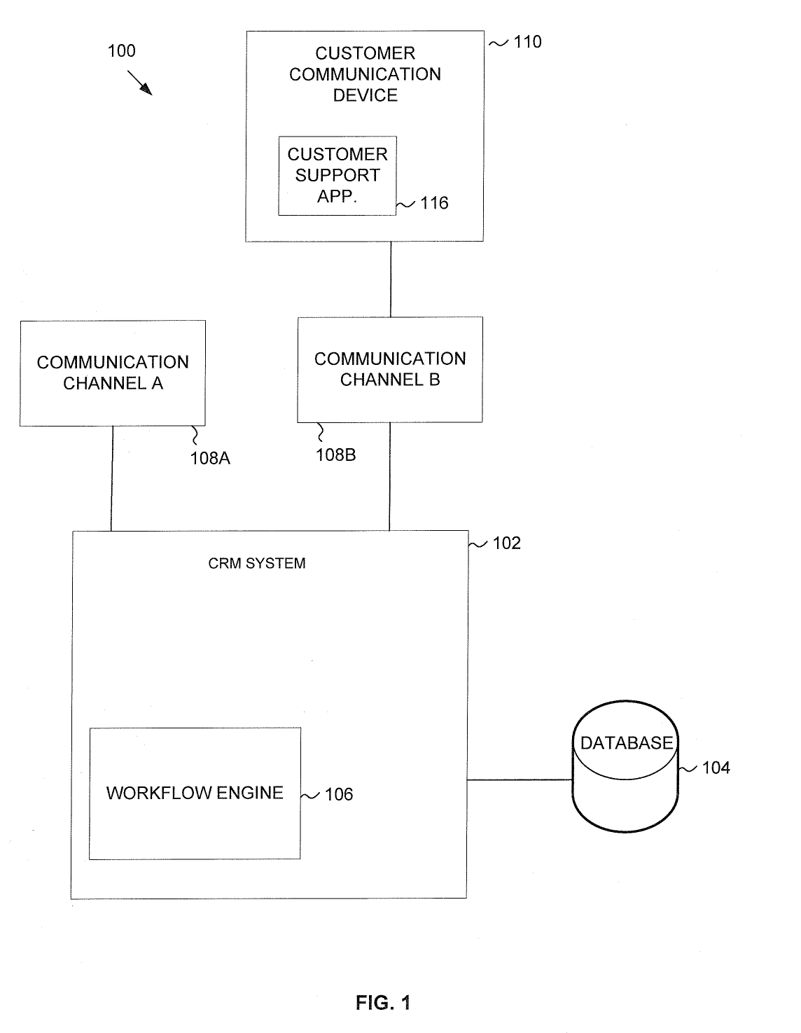

FIG. 1 is a block diagram of a system 100 according to embodiments of the invention. In some embodiments, system 100 includes a customer relationship management (CRM) system 102 having communications channels 108 and a customer communications device 110. CRM system 102 provides an interface for a company's sales and/or support staff to efficiently handle interactions with customers or potential customers. The functions provided by CRM system 102 in various embodiments include providing product information in response to queries and maintaining records of support calls or inquiries placed by customers.

Database 104 may be coupled to CRM system 102, and used to maintain product information and customer support information. Product information may include technical details regarding a business's products and/or services, and may also maintain configuration information for products that may be provided in various configurations. Further, database 104 may include information regarding requests by customers for support on products. Such requests may include requests for assistance in using a product, or requests to aid in solving a problem a customer is experiencing with a product. Although shown as one database in FIG. 1, database 104 may be distributed across multiple databases.

CRM system 102 may be coupled to various communications channels 108. A communications channel 108 can be any communications mechanism that can be used to communicate with a customer. Examples of such communications channels include telephone, text messaging systems, electronic (email) systems, social networking systems, web sites etc. A customer may initiate a contact with sales or support staff through any of the various communications channels supported by CRM system 102. Further, contact may be initiated using one communications channel (e.g., telephone), and continued through a different communications channel (e.g., email).

Communication channels may be directly connected (e.g., a phone line) or they may be connected via a broadcast medium such as a network (wired or wireless). In some embodiments, a network may be a collection of networks such as the Internet.

In some embodiments, CRM system 102 includes a workflow engine 106. Workflow engine may receives support or product inquiries and use various parameters in the queries, product information, and support/sales staff characteristics in order to route a request to the appropriate staff for handling. In general, workflow engines are known in the art, and typically include the ability to handle service level agreements (SLAs) to prioritize and route customers of varying levels to the appropriate work queues, skills based routing (SBR) to allow items to be routed to individuals with the appropriate skills to handle particular requests. The workflow engine 106 may provide automated search functionality that attempts to automatically match a request with reusable content, escalation ability to move items from one queue or assignment into another if specific business conditions are met, and many other standard business practices. CRM system 102 may receive updates, queue entries, task requests etc. as a result of actions performed by the workflow engine 106.

Customer communications device 110 is used by a customer to contact a business using one or more communications channels 108. In some embodiments, customer communications device 110 may be mobile phone. The mobile phone may be capable of communicating via multiple channels separately or simultaneously. For example, a mobile phone may communicate audio data through a telephone communications channel, provide text message capability of an SMS network, and send and receive data over a data network. Such data may include data communicated using a browser such as a web browser, or data sent and received from a customer support application 116 installed on the customer communications device 110. Customer communications device 110 will typically include a camera to capture still images and record video data.

In some embodiments, customer support application 116 may provide a customized interface for communications between a customer communications device 110 and CRM system 102.

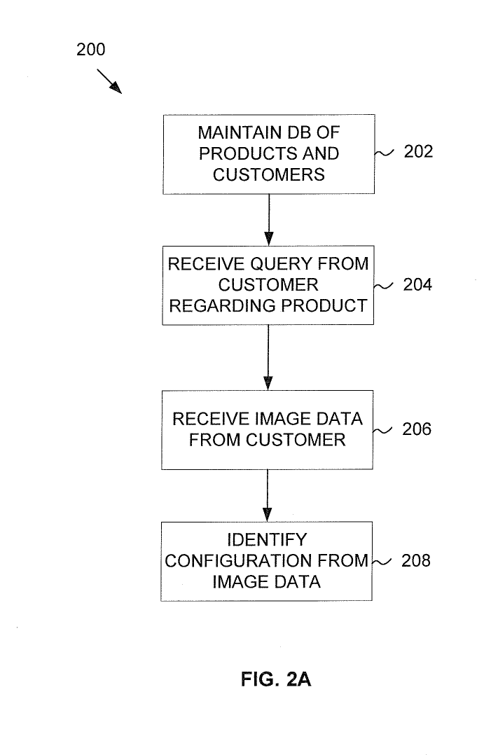

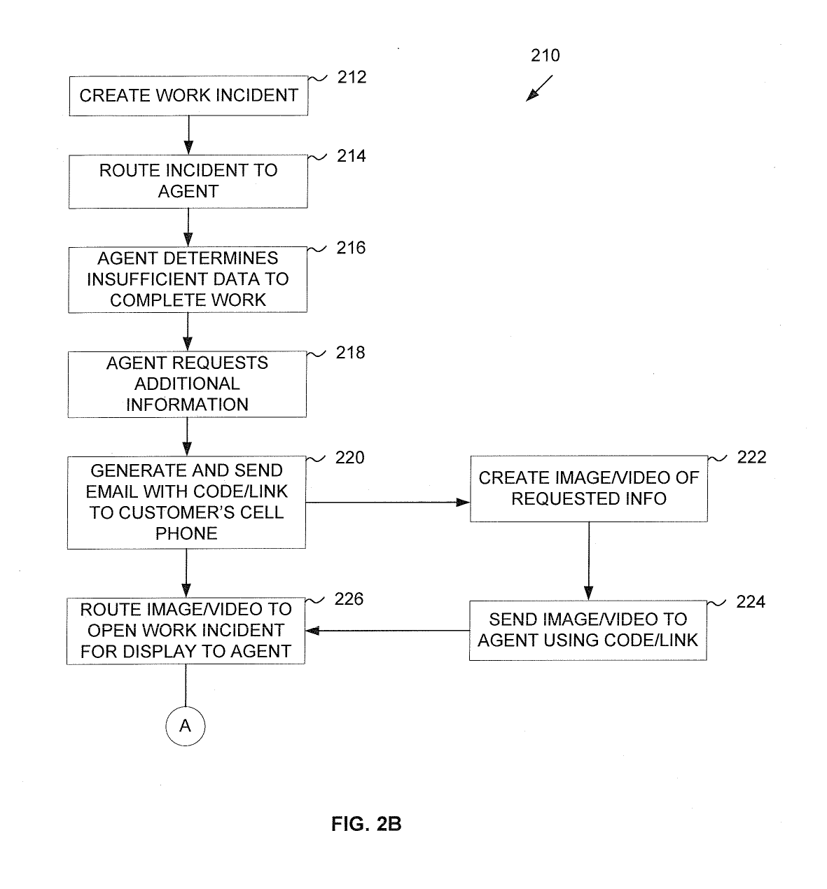

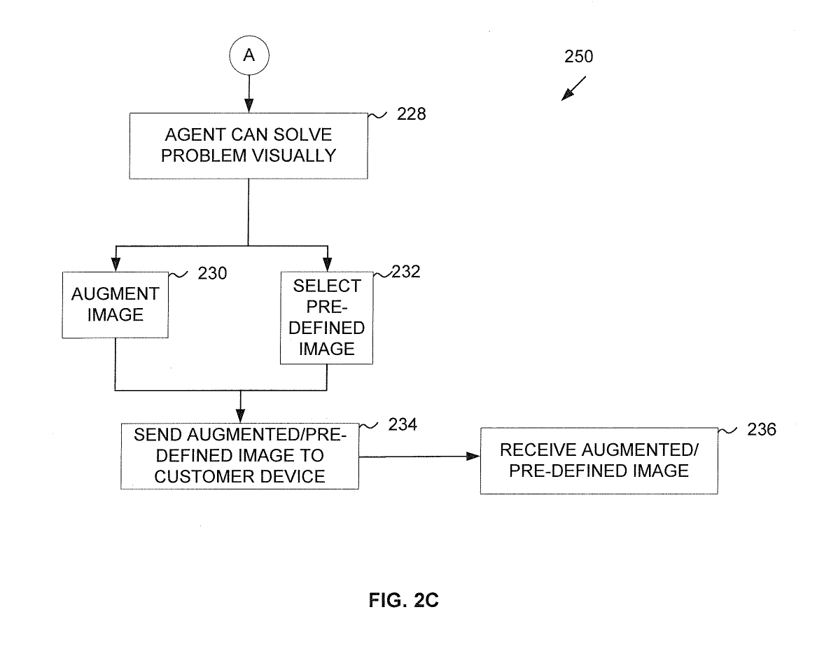

Further details on the operation of the above described components are described below with respect to FIGS. 2A-2C. FIGS. 2A-2C are flowcharts describing methods according to various embodiments. The methods may, in some embodiments, constitute computer programs made up of computer-executable instructions. Describing the methods by reference to a flowchart enables one skilled in the art to develop such programs including such instructions to carry out the method on suitable processors (the processor or processors of the computer executing the instructions from machine-readable media). The methods illustrated in FIGS. 2A-2C are inclusive of acts that may be taken by an operating environment 100 executing an exemplary embodiment of the invention.

FIG. 2A is a flowchart illustrating a method 200 for determining actions based on content analysis according to embodiments of the invention. Method 200 begins at block 202 with maintaining a database of products, services and/or customer interactions. The database may include information on different configurations for a product. For example, a base product may be available which can be configured with different components. Consider a computer for example. A base configuration may include a basic processor, a default amount of memory and a default hard drive. However, the computer may be sold in different configurations, for example, with a faster processor, more memory, or a larger capacity hard drive. Further, the configuration data may include software that is installed on a system. For example, a base configuration may come with little or no software installed, while an advance system may include more software than the base version.

Further, records of customer interactions may be maintained in the database. For example, requests for support or assistance with a product or service may be maintained in the database.

At block 204, a system executing the method receives a query from a customer (or potential customer) regarding a product or service. The query may be received from any of multiple communications channels (e.g., phone, email, chat, text message, web site form etc.).

At block 206, a system executing the method receives image data from the customer. The image data may comprise one or more images of a product, including the outside surfaces of the product or internal components of the product.

At block 208, the system uses the image data to identify a configuration for the product. Various forms of image analysis may be used to obtain data that can be used to match the product (or product components) with a product configuration. For example, text, bar codes, logos, pictures or other items appearing on the surface of the product may be analyzed and used to automatically determine a product configuration. As noted above, the product configuration may include details regarding the hardware and software for a product.

Additionally, the presence of particular components identified in the image data may be used to determine a product configuration. Further, an arrangement of components (e.g., the location of components relative to one another) within or on a product may be used to identify a product configuration.

The product configuration information obtained at block 208 may be used in various ways. For example, a customer support agent may use the product configuration information to assist in answering a customer's query or in solving a problem the customer may be having with the product. The product configuration data may be used to route the query to staff that is most appropriate for dealing with the query. Additionally, the configuration information may be used in a sales environment to allow a customer to order a particularly configured product that may be displayed in a store. For example, a store may display products that are available for ordering on-line. The products, on the surface, may look substantially the same, with the difference between products being internal components or software installed with the product. An image of a bar code, logo, model number etc. taken from a product having desired configuration may be submitted by the customer and used by an order entry system to identify the product and configuration desired by the customer.

FIG. 2B is a flowchart illustrating a method 210 for processing a work incident according to embodiments of the invention. At block 212, a work incident is created. A work incident, also referred to as a support incident, is a record of a contact with a customer that results in work for a support agent. In some embodiments, the work incident may be created as a result of contact by a customer with a company. The contact may be initiated through any of a number of communications channels, including phone, text message, email, chat, web site etc.

At block 214, the work incident is routed to a support agent. Routing may be as simple as routing the work incident to any available support agent, or it may involve using available data to route the work incident to a support agent that is indicated has having particular capabilities for handling the work incident.

At block 216, the support agent determines that there is insufficient data to complete or close the work incident. As a result of this determination, at block 218 the support agent requests additional information from the customer. The request may be issued from the same communications channel that the customer used to initiate the contact, or it may be on a different communications channel. For example, the support agent may request additional information during a phone call initiated by the customer. The request may include asking that the customer supply image data of the product that is the subject of the customer's query, along with a description of the image or images the support agent desires.

At block 220, the system executing the method generates a link or encodes an identifier for the work incident that provides a location for the customer to send the image data. The link or encoded identifier is generated in a manner to direct the incoming image to the support agent's system and attach it to the active support incident. The system sends the link or encoded identifier to the customer communications device (e.g., cell phone). In various embodiments, this protocol or link could be human memorable for vocal communications. For example, in some embodiments, the link or encoded identifier may be sent in a message via a communications protocol such as email, SMS (Short Message Service) or other message communications format. Examples of such links include:

http://company.com/ticketsystem/imageupload/caseid=xyz123?image=1a

Caseidxyz123@company.com

406-555-1212#456234

Alternatively, the link or encoded identifier may be relayed to the customer verbally over the phone. It is desirable in such embodiments that the link or encoded identifier be constructed in a manner that allows the link or identifier to be easily relayed and interpreted. Examples of such link types include:

Noun/verb/noun, e.g.: catjumpsdog@company.com

Consonant/vowel/consonant, e.g.: rebgig@company.com

Those of skill in the art can easily identify additional communication protocols which could associate an incoming image or video with a currently open and active support ticket by any of a variety of communication methodologies and encodings of the support ticket identifier.

At block 222, the customer creates the requested image or video data on their communications device (i.e., mobile phone). At block 224, the image or video data is sent using the link or encoded identifier provided at block 220.

At block 226, the image or video data is received and routed to the work incident for display to the support agent. As described above, the link or encoded is used to route the incoming image or video data to the correct support incident and support agent. Should additional images or video be needed the customer can reuse the same link to upload additional pictures or an additional link can be provided.

The methods described herein may take advantage of various aspect of a customer's communications device. For example, a computer telephony interface (CTI) is used to properly route the link if handled completely electronically or provide an interface for handling the human memorable link information for vocal transcription. Further, it is desirable that the consumer's phone be (or optionally, in the case of verbal relay of the human-memorable link) able to receive an incoming link and be able to use that link as the sending location for a photographic image produced by the phone. Additionally, (but optionally) advanced cellular phones may be able to provide specific information to the CTI to more clearly specify details necessary to properly format the system-generated link for the specific phone model. For purposes of example only such cellular phones include, but are not limited to the following: iPhone, Android, Blackberry and Nokia. Additional phone configurations may include language or region settings, particularly time of day, connectivity level (3G and 4G), WiMax and browser versions, etc.

FIG. 2C illustrates a method 250 for continuing processing of a work incident according to embodiments of the invention. Method 250 begins at block 228 where a support agent concludes that a visual response to the work incident is desirable. The visual response may take a variety of forms. For example, at block 230, the support agent may augment or annotate images or video previously sent by the customer at block 224. The annotations or augmentations may illustrate differences between the current state of the product or product configuration and a desired state of the configuration or assembly of the customer's product.

Additionally, or alternatively, at block 232 a predefined image or video that is deemed useful in illustrating a resolution for the work incident may be selected by the support agent. Such images and video could be generic instructional content or specific to this interaction. Further, the support agent may generate an image or video that may be useful in resolving the work incident.

At block 234, the images or video from blocks 230 and/or 232 are sent to the customer's communications device and at block 236 may be received and displayed to the customer.

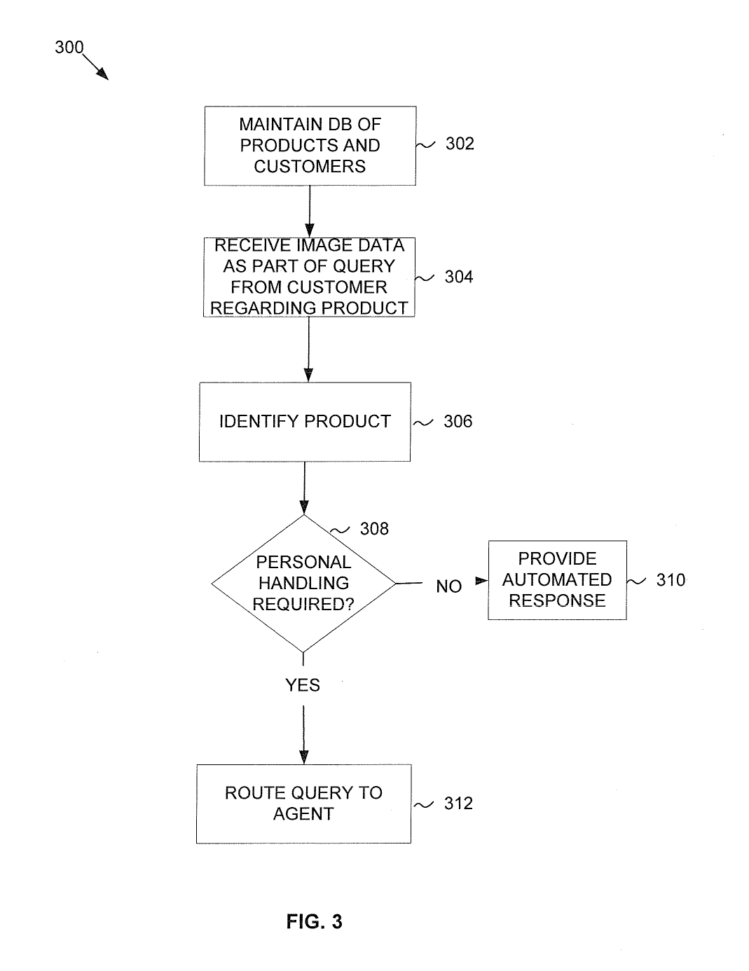

FIG. 3 is a flowchart illustrating a method 300 for handing a product query according to embodiments of the invention. The method begins at block 302 with maintaining a database of product and customer information. As at block 202 of FIG. 2, the database may include information on different configurations for a product. Further, the database may include information regarding customer interactions with the company.

At block 304, a system executing the method receives a query regarding a product or service from a customer. The query may include image data regarding a product or service associated with a product.

At block 306, a system executing the method uses the image data to identify one or more products (and potentially product configurations).

At block 308, the system determines whether personal handling is required for the query. The determination may be made based on any combination of a number of factors. Such factors include the number of models within a product line, the number of configurations for the product, the opportunity for selling additional related products or product options etc.

If the system determines that personal handling is not required, then at block 310 an automated response may be provided. The automated response may include sending the customer to an on-line order page, an on-line help page, or an on-line specifications page that provides information about the product.

If the system determines that personal handling is required, then at block 312 the query is routed to a support agent for handling. The support agent may then interact with the customer to resolve the customer's query.

As an example of the above, consider a company that sells both vacuum cleaners and pool cleaners. Further assume the company has 20 models of the vacuum cleaner and they all have subtle variations, but the company only offers one pool cleaner. If a customer provides takes a picture of a pool cleaner using their communications device and sends the picture as part of a product query, the system may determine that because there is only one model of pool cleaner, that no personal handling is required and in response to the query, the system sends the customer to the purchase page for the pool cleaner.

Alternatively, if the customer takes a picture of one of the company's vacuums, then the system may determine that personal handling is desirable because of the opportunity to up-sell or cross-sell. For example, the support agent may try to go through a cross sell process to tell the customer that if they are interested in a particular vacuum, then they will need extra brushes. Or the support agent may speak with the customer about purchasing a more capable vacuum in the company's line if the square footage is over certain thresholds.

In some embodiments, a product sales and support application 116 (FIG. 1) may be installed on a smart phone. Such an application may facilitate the interaction between the support agent or product representative and the consumer to relay various images and video back and forth during an interaction, allowing the link coding to be even more automatic and thus transparent to the consumer and agent.

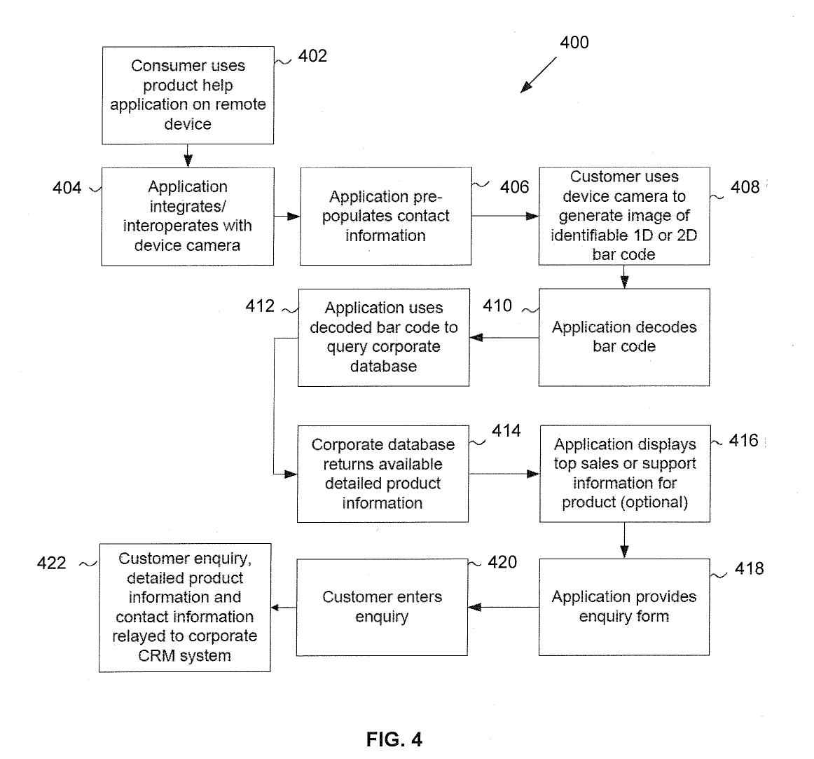

FIG. 4 is a flowchart illustrating a method 400 for using a sales and support application on a customer's communication device to interact with a CRM system and support agent. The method begins at block 402, where a customer initiates the support application 116.

At block 404, the support application performs any necessary actions to integrate and operate with a camera on the customer's communications device.

At block 406, the support application pre-populates contact information. The contact information may be obtained from data maintained on the customer's communications device.

At block 408 the customer uses the camera on the communications device to obtain an image of the product that is to be the subject of the query. The image may contain a bar code (either 1D or 2D) or may be other identifying information.

At block 410, the support application decodes the identifying information (e.g., the bar code).

At block 412, the support application uses the decoded indentifying information to issue a query to the corporate database.

At block 414, the corporate database returns details regarding the product in response to the query.

At block 416, the support application on the customer's communications device optionally displays the details, including any sales and/or support information returned from the corporate database in response to the query.

At block 418, the support application displays an enquiry form.

At block 420, the customer enters an enquiry regarding the product in a field of the enquiry form.

At block 422 the enquiry, along with the product detail information and customer contact information is sent to a company's CRM system for handling.

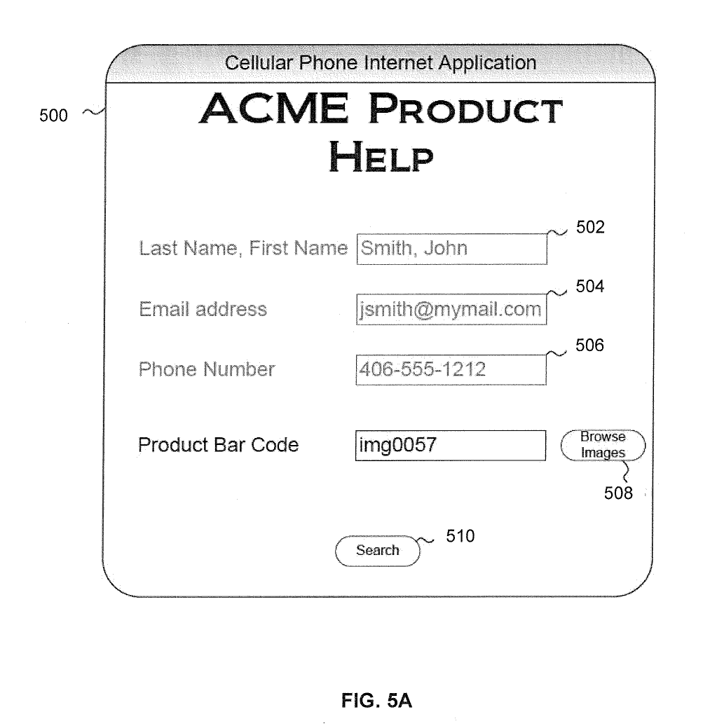

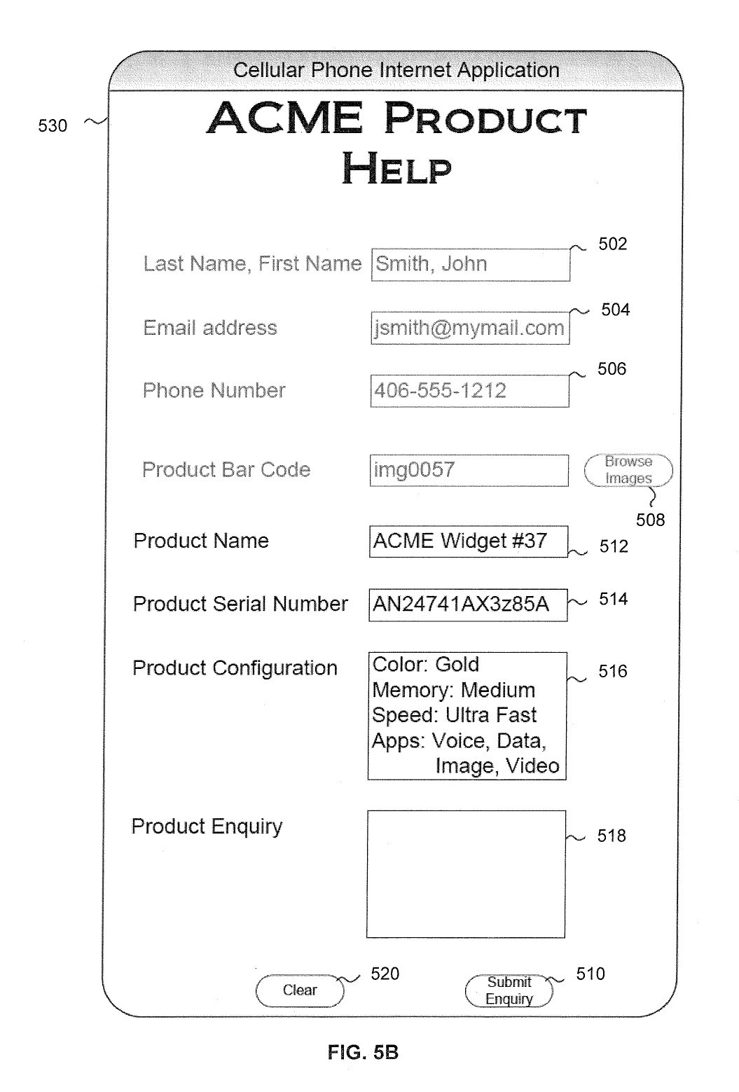

FIGS. 5A and 5B are example user interfaces that may be used in conjunction with the methods described above. FIG. 5A illustrates an example web page that may be presented to a customer on their communications device. For example, the customer may visit a web page for product sales or support. The web page could provide fields for data entry to describe contact information (e.g., name 502, email address 504 and phone number 506), product information and question particulars. In lieu of various detailed product fields, an option to upload an image of a barcode or other identifying information for the equipment is provided (508). Alternatively, an image of the product box, manual or product itself may be uploaded. This image upload may be a direct file upload, or it may be a short encoded identifier that can be entered into a cell phone to directly send the image and have it connected to the enquiry. As one of ordinary skill in the art can determine, image data 508 could involve either a direct connection to the camera function on the device or alternately allow the identification of previously saved photographs or video.

As discussed above, this image is subsequently used by the sales and support system to identify the relevant product details that may otherwise be difficult to have a consumer supply. If the image is a bar code or other similar electronically identifiable encoding, the image could then be electronically decoded and compared against a database of products, potentially identifying the product to the level of a custom configuration of an individual item. This very specific identification can then aid the responding sales or support agent with sufficient information with which to provide very detailed information about the product, its configuration, functionality, license status and service issues.

FIG. 5B illustrates an example screen for a support application installed on a customer's communications device such as a cell phone. Contact information and image data elements 502-508 are as discussed above and may be automatically pre-populated using information obtained from the phone. Additionally, the example screen includes a field 518 for a short text or voice enquiry. Product name field 512, product serial number 514 and product details 516 may be automatically populated using the method illustrated in FIG. 4. The application then initiates either a phone or electronic interaction with the company with all the relevant product (512, 514, 516) and contact details (502, 504, 506) supplied and annotated with the enquiry. As one of ordinary skill in the art can determine, image data 508 could involve either a direct connection to the camera function on the device or alternately allow the identification of previously saved photographs or video.

Further, one of ordinary skill in the art will appreciate using the disclosure above that variations exist to the use cases for remote visual communication between a consumer and a product representative for such activities as identifying broken parts, identifying replacement parts, or identifying part compatibility, upgrade capabilities and the like.

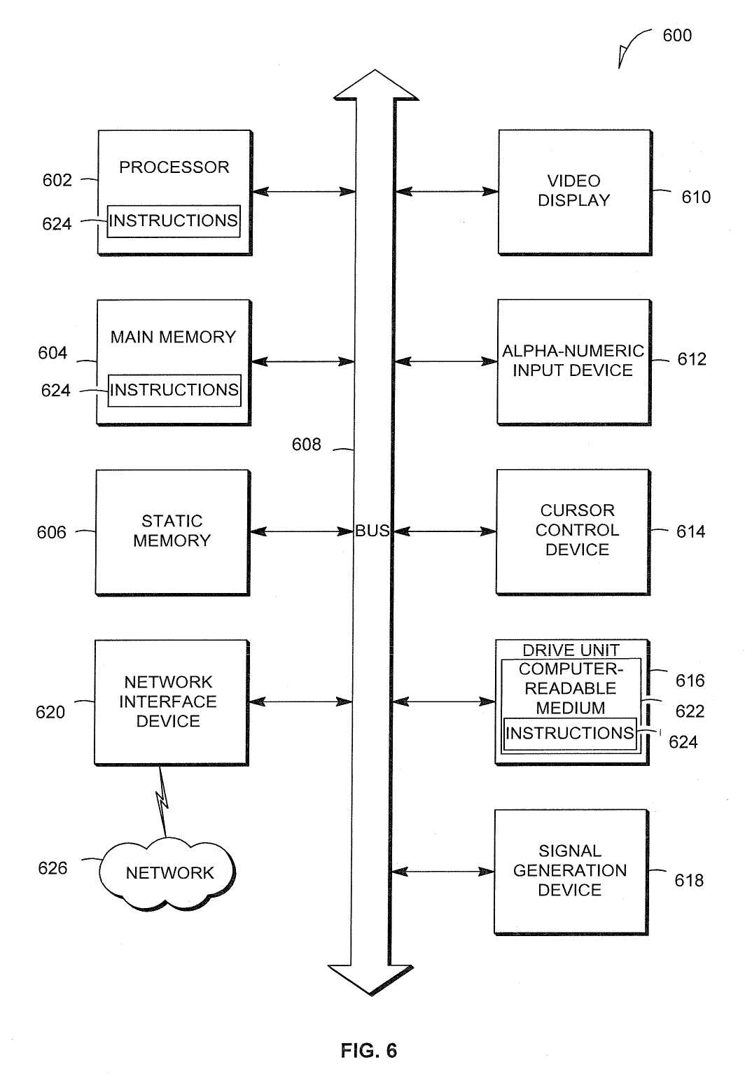

FIG. 6 is a block diagram of an example embodiment of a computer system 600 upon which embodiments of the inventive subject matter can execute. The description of FIG. 6 is intended to provide a brief, general description of suitable computer hardware and a suitable computing environment in conjunction with which the invention may be implemented. In some embodiments, the invention is described in the general context of computer-executable instructions, such as program modules, being executed by a computer. Generally, program modules include routines, programs, objects, components, data structures, etc., that perform particular tasks or implement particular abstract data types.

As noted above, the system as disclosed herein can be spread across many physical hosts. Therefore, many systems and sub-systems of FIG. 6 can be involved in implementing the inventive subject matter disclosed herein.

Moreover, those skilled in the art will appreciate that the invention may be practiced with other computer system configurations, including hand-held devices, multiprocessor systems, microprocessor-based or programmable consumer electronics, network PCS, minicomputers, mainframe computers, and the like. The invention may also be practiced in distributed computer environments where tasks are performed by I/O remote processing devices that are linked through a communications network. In a distributed computing environment, program modules may be located in both local and remote memory storage devices.

In the embodiment shown in FIG. 6, a hardware and operating environment is provided that is applicable to both servers and/or remote clients.

With reference to FIG. 6, an example embodiment extends to a machine in the example form of a computer system 600 within which instructions for causing the machine to perform any one or more of the methodologies discussed herein may be executed. In alternative example embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. Further, while only a single machine is illustrated, the term “machine” shall also be taken to include any collection of machines that individually or jointly execute a set (or multiple sets) of instructions to perform any one or more of the methodologies discussed herein.

The example computer system 600 may include a processor 602 (e.g., a central processing unit (CPU), a graphics processing unit (GPU) or both), a main memory 604 and a static memory 606, which communicate with each other via a bus 608. The computer system 600 may further include a video display unit 610 (e.g., a liquid crystal display (LCD) or a cathode ray tube (CRT)). In example embodiments, the computer system 600 also includes one or more of an alpha-numeric input device 612 (e.g., a keyboard), a user interface (UI) navigation device or cursor control device 614 (e.g., a mouse), a disk drive unit 616, a signal generation device 618 (e.g., a speaker), and a network interface device 620.

The disk drive unit 616 includes a machine-readable medium 622 on which is stored one or more sets of instructions 624 and data structures (e.g., software instructions) embodying or used by any one or more of the methodologies or functions described herein. The instructions 624 may also reside, completely or at least partially, within the main memory 604 or within the processor 602 during execution thereof by the computer system 600, the main memory 604 and the processor 602 also constituting machine-readable media.

While the machine-readable medium 622 is shown in an example embodiment to be a single medium, the term “machine-readable medium” may include a single medium or multiple media (e.g., a centralized or distributed database, or associated caches and servers) that store the one or more instructions. The term “machine-readable medium” shall also be taken to include any tangible medium that is capable of storing, encoding, or carrying instructions for execution by the machine and that cause the machine to perform any one or more of the methodologies of embodiments of the present invention, or that is capable of storing, encoding, or carrying data structures used by or associated with such instructions. The term “machine-readable medium” shall accordingly be taken to include, but not be limited to, solid-state memories and optical and magnetic media that can store information in a non-transitory manner, i.e., media that is able to store information for a period of time, however brief. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and CD-ROM and DVD-ROM disks.

The instructions 624 may further be transmitted or received over a communications network 626 using a transmission medium via the network interface device 620 and utilizing any one of a number of well-known transfer protocols (e.g., FTP, HTTP). Examples of communication networks include a local area network (LAN), a wide area network (WAN), the Internet, mobile telephone networks, Plain Old Telephone (POTS) networks, and wireless data networks (e.g., WiFi and WiMax networks). The term “transmission medium” shall be taken to include any intangible medium that is capable of storing, encoding, or carrying instructions for execution by the machine, and includes digital or analog communications signals or other intangible medium to facilitate communication of such software.

Although an overview of the inventive subject matter has been described with reference to specific example embodiments, various modifications and changes may be made to these embodiments without departing from the broader spirit and scope of embodiments of the present invention. Such embodiments of the inventive subject matter may be referred to herein, individually or collectively, by the term “invention” merely for convenience and without intending to voluntarily limit the scope of this application to any single invention or inventive concept if more than one is, in fact, disclosed.

As is evident from the foregoing description, certain aspects of the inventive subject matter are not limited by the particular details of the examples illustrated herein, and it is therefore contemplated that other modifications and applications, or equivalents thereof, will occur to those skilled in the art. It is accordingly intended that the claims shall cover all such modifications and applications that do not depart from the spirit and scope of the inventive subject matter. Therefore, it is manifestly intended that this inventive subject matter be limited only by the following claims and equivalents thereof

The Abstract is provided to comply with 37 C.F.R. §1.72(b) to allow the reader to quickly ascertain the nature and gist of the technical disclosure. The Abstract is submitted with the understanding that it will not be used to limit the scope of the claims.

What is claimed is:

1. A method for execution by one or more processors, the method comprising:
maintaining product configuration information for a plurality of products, the plurality of products having a plurality of configurations;
receiving a product query, the product query including image data associated with a product of the plurality of products;
determining from the image data a configuration of the plurality of configurations for the product; and
providing the configuration information.

2. The method of claim 1, and further comprising generating an identifier for a work incident regarding the product;
wherein the product query includes the work incident identifier.

3. The method of claim 2, and further comprising routing the image data to the work incident based on the identifier for the work incident.

4. The method of claim 1, wherein image data comprises a bar code.

5. The method of claim 1, wherein providing the configuration information includes sending the configuration information to a communications device.

6. The method of claim 1, wherein providing the configuration information includes displaying the configuration information on a display.

7. The method of claim 1, and further comprising:
receiving annotations to be applied to the image data; and
sending the image data with the annotations to a customer communications device.

8. A method for execution by one or more processors, the method comprising:
maintaining product information for a plurality of products;
receiving a product query, the product query including image data associated with one or more products of the plurality of products;
using the image data to retrieve data regarding the one or more products;
upon determining based on data regarding the one or more products that the query is to be handled in-person, routing the query to the support representative; and
upon determining based on data regarding the one or more products that the query is not to be handled in-person, providing an automated response to the query.

9. The method of claim 8, wherein the automated response includes sending a web page to a customer communications device.

10. A method for execution by one or more processors of a hand held communications device, the method comprising:
presenting a user interface for a product query;
receiving image data for identifying a product that is the subject of the query;
obtaining product details based on the image data;
obtaining contact information from the hand held communications device;
populating fields of the user interface with the contact information and the product details; and
sending data in the one or more fields of the user interface to a customer relationship management system.

11. The method of claim 10, wherein the image data for identifying a product comprises a bar code.

12. A system comprising:
one or more processors; and
a customer relationship management (CRM) system executable by the one or more processors to:
maintain data associated with a work incident for a product;
receive from a customer communications device a digital image comprising at least a portion of the product, and
identify configuration information for the product using the digital image.

13. The system of claim 12, wherein the CRM system generates an identifier for the work incident regarding the product and wherein the product query includes the work incident identifier.

14. The system of claim 13, and further comprising a workflow manager, wherein the workflow manager routes the image data to the work incident based on the identifier for the work incident.

15. The system of claim 12, wherein image data comprises a bar code.

16. The system of claim 12, wherein the CRM system sends the configuration information to the customer communications device.

17. The system of claim 12, wherein CRM system displays the configuration information on a display.

18. The system of claim 12, wherein the CRM system:
receives annotations to be applied to the image data; and
sends the image data with the annotations to the customer communications device.

19. A system comprising:
one or more processors; and
a database to maintain data associated with a plurality of products;
a CRM system executable by the one or more processors to:
receive a query from a customer communications device, the query including a digital image comprising at least a portion of a product,
retrieve data regarding the product based on the digital image,
determining using the data that the query is to be handled in-person; and
a workflow manager to route the query for in-person handling.

20. The system of claim 19, wherein the CRM system determines using the data that the query is not to be handled in-person and provides an automated response to the query.

21. The system of claim 20, wherein the automated response comprises a web page to be sent to the customer communications device.

22. A machine-readable medium having stored thereon instructions for causing one or more processors to perform operations including:
maintaining product configuration information for a plurality of products, the plurality of products having a plurality of configurations;
receiving a product query, the product query including image data associated with a product of the plurality of products;
determining from the image data a configuration of the plurality of configurations for the product; and
providing the configuration information.

23. The machine-readable medium of claim 22, wherein the operations further comprise generating an identifier for a work incident regarding the product;
wherein the product query includes the work incident identifier.

24. The machine-readable medium of claim 23, wherein the operations further comprise routing the image data to the work incident based on the identifier for the work incident.

25. The machine-readable medium of claim 22, wherein image data comprises a bar code.

26. The machine-readable medium of claim 22, wherein providing the configuration information includes sending the configuration information to a communications device.

27. The machine-readable medium of claim 22, wherein providing the configuration information includes displaying the configuration information on a display.

28. The machine-readable medium of claim 22, wherein the operations further comprise:
receiving annotations to be applied to the image data; and
sending the image data with the annotations to a customer communications device.

29. A machine-readable medium having instructions stored thereon to cause one or more processors to perform operations comprising:
maintaining product information for a plurality of products;
receiving a product query, the product query including image data associated with one or more products of the plurality of products;
using the image data to retrieve data regarding the one or more products;
upon determining based on data regarding the one or more products that the query is to be handled in-person, routing the query to the support representative; and
upon determining based on data regarding the one or more products that the query is not to be handled in-person, providing an automated response to the query.

30. The machine-readable medium of claim 29, wherein the automated response includes sending a web page to a customer communications device.
